(19) United States
(12) Patent Application Publication
(10) Pub. No.: US 2016/0150387 A1
(43) Pub. Date: May 26, 2016

(54) TextMuse Message Generator

(71) Applicant: Todd Myers Communications, Inc., Kirkland, WA (US)

(72) Inventors: James T. Myers, Sammamish, WA (US); Peter A. Tucker, Spokane, WA (US); Patrick B. Coussens, Kirkland, WA (US)

(21) Appl. No.: 14/951,471

(22) Filed: Nov. 24, 2015

Related U.S. Application Data
(60) Provisional application No. 62/084,538, filed on Nov. 25, 2014.

(51) Int. Cl. H04W 4/14; H04M 1/2745

(52) U.S. Cl. CPC H04W 4/14; H04M 1/274583

(57) ABSTRACT

In embodiments of TextMuse message generator, a computing device, such as a mobile phone or similar portable communication device, can maintain user contacts in memory and execute software instructions as a TextMuse application that interfaces with a messaging client application executing on the computing device. The TextMuse application can optionally receive a selection of one or more user contacts, receive an additional selection of preconfigured messaging content, and generate a content-ready text message that includes the preconfigured messaging content. The TextMuse application can then initiate communication of the content-ready text message, by the messaging client application, to client devices that are associated with the one or more user contacts.

### RELATED APPLICATION

This application claims priority to U.S. Provisional Patent Application Ser. No. 62/084,538 filed Nov. 25, 2014 entitled “TextMuse Message Generator”, the disclosure of which is incorporated by reference herein in its entirety.

### BACKGROUND

Many users of mobile devices, such as mobile phones and tablet devices, use text messaging as a preferred form of communication, even more so than a phone call or an email message. Commonly referred to as “texting”, a user can send a text from one mobile device to another as a brief, electronic message. A text message may also be commonly referred to as an SMS message (e.g., a message communicated using the Short Message Service), or may be commonly referred to as an MMS message (e.g., a message communicated using Multimedia Messaging Service), which may include image, hyperlinks, video, and/or audio content. A mobile device can implement both the SMS and MMS protocols for communicating text messages. Further, a user may send a text message to interact with an automated system, such as to check data usage, to order a product or service, or reply to a marketing request.

As convenient as text messaging is for users to communicate a quick message or image, conventional messaging lacks ease of use when creating content and sharing existing content. The small interface and difficulty in composing texts make it difficult to send anything other than short messages. Additionally, while there are many platforms that make it possible to share content with a large, untargeted group of people (commonly known as “social media”), there are no applications that provide a simple way to share updated content through SMS or MMS. Finally, while it is possible to send texts to groups of people, it can be difficult to manage and edit those groups. Social media has changed the way people communicate, yet text messaging has not adapted to provide the content and ease of use that many device users have become accustomed for a positive user experience with social media.

### SUMMARY

This Summary introduces features and concepts of TextMuse message generator, which is further described below in the Detailed Description and/or shown in the Figures. This Summary should not be considered to describe essential features of the claimed subject matter, nor used to determine or limit the scope of the claimed subject matter.

TextMuse message generator is described. In embodiments, a computing device, such as a mobile phone or similar portable communication device, can maintain user contacts in memory and execute software instructions as a TextMuse application that interfaces with a messaging client application executing on the computing device. The TextMuse application is implemented to optionally receive a selection of one or more user contacts, and receive an additional selection of preconfigured messaging content. The TextMuse application receives the preconfigured messaging content from one or more content service providers, where the preconfigured messaging content is available for selection to include in a content-ready text message. The TextMuse application can generate the content-ready text message that includes the preconfigured messaging content. The TextMuse application can then initiate communication of the content-ready text message, by the messaging client application, to client devices that are associated with the one or more user contacts. The TextMuse application is independent from the messaging client application, and independently generates the content-ready text message to include the preconfigured messaging content. The TextMuse application transfers the content-ready text message to the messaging client application that manages communication of the content-ready text message to the client devices.

A method is described for a TextMuse message generator. The method includes a TextMuse application receiving a selection of preconfigured messaging content, and receiving the preconfigured messaging content from one or more content service providers, where the preconfigured messaging content is available for selection to include in a content-ready text message. The method includes the TextMuse application generating the content-ready text message that includes the preconfigured messaging content, and interfacing with a messaging client application to initiate the content-ready text message being communicated, by the messaging client application, to client devices that are associated with user contacts. The method also includes the TextMuse application transferring the content-ready text message to the messaging client application that manages communication of the content-ready text message to the client devices.

In another aspect of TextMuse message generator, a computing device has a computer-readable storage memory device that stores the TextMuse application as software instructions that are executable by the computing device to perform operations including to receive a selection of a user contact, receive an additional selection of preconfigured messaging content, and receive the preconfigured messaging content from one or more content service providers, where the preconfigured messaging content is available for selection to include in the content-ready text message. The computing device operations also include to generate the content-ready text message that includes at least the preconfigured messaging content, and interface with a messaging client application executing on the computing device to initiate the content-ready text message being communicated to a client device that is associated with the user contact. The computing device operations also include to transfer the content-ready text message to the messaging client application that manages communication of the content-ready text message to the client device.

### BRIEF DESCRIPTION OF THE DRAWINGS

Embodiments of TextMuse message generator are described with reference to the following Figures. The same numbers may be used throughout to reference like features and components that are shown in the Figures:

FIG. 1 illustrates an example system in which embodiments of a TextMuse message generator can be implemented.

FIGS. 2-8 illustrate example user interfaces of a TextMuse application implemented on a mobile device in accordance with one or more embodiments of a TextMuse message generator.

FIG. 9 illustrates example methods of a TextMuse message generator in accordance with one or more embodiments of the techniques described herein.

FIG. 10 illustrates an example system with an example device that can implement embodiments of a TextMuse message generator.

### DETAILED DESCRIPTION

Embodiments of a TextMuse message generator system and methods are described in which a computing device, such as a mobile phone, tablet device, or other portable communication device includes a TextMuse application that is implemented to allow a user to compose and send text messages (also referred to as “texts”) to designated people in a contacts list, such as friends, family, social groups, and business associates. The TextMuse application automatically provides text messages that are preconfigured and downloaded for a user from a TextMuse service, and in different categories of text messages that can be chosen by the user. The TextMuse application can alert a user at a specific time, and the user can then send content-ready text messages at the touch of a button. The TextMuse application is not a messaging client application (e.g., a SMS or a MMS), but rather can be used independent from messaging client applications, and independently generates content-ready text messages that include preconfigured messaging content designated for selected user contacts.

The TextMuse application collates the content and optionally, designated recipients, where all of the work of content assimilation and/or user contacts designation is performed independent of a messaging client application on a computing device. The TextMuse application can generate the content-ready text messages that are then transferred to a messaging client application that manages communication of the content-ready text message to the client devices associated with the selected user contacts.

In implementations, the TextMuse application on a computing device, such as a mobile phone or tablet device, also provides users with a technique to send photos from the device to established recipient groups. New suggested text messages are occasionally updated and refreshed at the TextMuse service, and although preconfigured, may be edited before sending. Users can also provide and guide content by suggesting text messages that can be used as preconfigured messaging content, and communicate the suggested text messages to the TextMuse service for use by others. Users can also control the text messages included in a category that highlights the most common texts during the past few hours, the past day, or for any other duration of time. TextMuse also provides suggestions for text messaging content from different categories, recently used categories, and contacts that a user may have texted recently. Messages sent using TextMuse also appear in the messaging feed on a mobile device, integrated along with texts sent using the conventional message service associated with the device.

While features and concepts of TextMuse message generator can be implemented in any number of different devices, systems, networks, environments, architectures, and/or configurations, embodiments of TextMuse message generator are described in the context of the following example devices, systems, and methods.

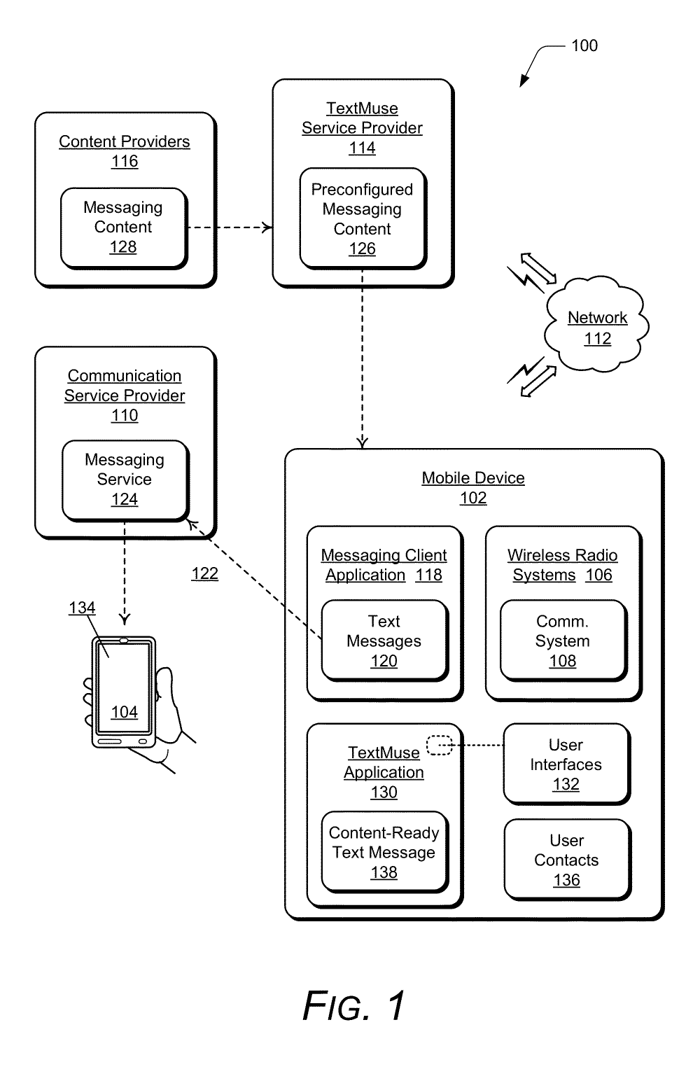

FIG. 1 illustrates an example system 100 in which embodiments of a TextMuse message generator can be implemented. The example system 100 includes a mobile device 102, such as any type of computing device, mobile phone, tablet device, media playback device, or other computing, communication, gaming, entertainment, and/or electronic media devices. Although described in the context of the mobile device 102, the techniques of a TextMuse message generator can similarly be implemented on any computing device, such as on a desktop computer or work station that implements a messaging client. The mobile device 102 can be implemented with various components, such as a processing system and memory, and with any number and combination of differing components as further described with reference to the example device shown in FIG. 10.

The example system 100 also includes a client device 104 (also referred to herein as an additional device). Although shown as a mobile phone, the client device 104 may be implemented as any type of mobile and/or computing device, such as described with reference to the mobile device 102. Further, although only two devices are shown in this example (i.e., the mobile device 102 and the client device 104), the client device 104 is representative of one or multiple different devices configured for communication with the mobile device 102, and is identified as a client device simply for convenience of discussion to differentiate between the mobile device and the client device. Further still, the client device 104 may also be implemented with various components, such as a processing system and memory, and with any number and combination of differing components as further described with reference to the example device shown in FIG. 10.

The mobile device 102 can include different wireless radio systems 106, such as for Wi-Fi, Bluetooth™, Mobile Broadband, LTE, or any other wireless communication system or format. In this example, the mobile device 102 implements a communication system 108, which generally includes a radio device, antenna, and chipset that is implemented for wireless communications via a communication service provider 110. In implementations, any of the devices (e.g., the mobile device 102 and the client device 104) can be implemented for wireless communications, such as text messaging, via the communication service provider.

Any of the devices, servers, and/or services described herein can communicate via a network 112, such as for data communication between the mobile device 102, the client device 104, the communication service provider 110, a TextMuse service provider 114, and content providers 116. The network 112 can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

Generally, the mobile device 102, as well as the client device 104, includes a messaging client application 118, such as any type of messaging, instant messaging, and/or communication application via which the devices can exchange wireless communications, such as in the form of text messages 120 that may include text, data, images, video, and/or audio. For example, a user of the mobile device 102 may compose a text message 120 that is then communicated at 122 from the mobile device to the client device 104 via the communication service provider 110 over the network 112. In this example, the communication service provider 110 includes a messaging service 124 that is implemented to receive and distribute the text messages between the devices.

The example system 100 also includes the TextMuse service provider 114 for distribution of preconfigured messaging content 126 to client devices, such as to the mobile device 102. The TextMuse service provider 114 can receive any type of messaging content 128 from one or more of the content providers 116, and create the preconfigured messaging content 126. The messaging content 128 can include any type of content that may be included in a text message, such as text, data, images, photos, renditions, video, video previews, audio, music, hyperlinks to content, and/or any other types and formats of content that may be included in a text message.

Further, the TextMuse service provider 114 can create the preconfigured messaging content 126 that includes any combination of the provided messaging content 128 from the content providers. For example, the preconfigured messaging content 126 can be created as text messages that include any combination of the provided text, data, images, photos, renditions, video, video previews, audio, music, and/or hyperlinks to content, as well as photos and other content from a user device. In implementations, some or all of the preconfigured messaging content 126 can be maintained by the TextMuse service provider 114 and/or downloaded to the mobile device 102.

The mobile device 102 includes a TextMuse application 130, which may be integrated as a component of the messaging client application 118, or implemented as an independent software application on the mobile device 102. The TextMuse application 130 can be implemented as a software application or module, such as executable software instructions (e.g., computer-executable instructions) that are executable with a processing system of the mobile device to implement embodiments of a TextMuse message generator. The TextMuse application 130 can be stored on computer-readable storage memory device, such as any suitable memory device or electronic data storage implemented by the mobile device.

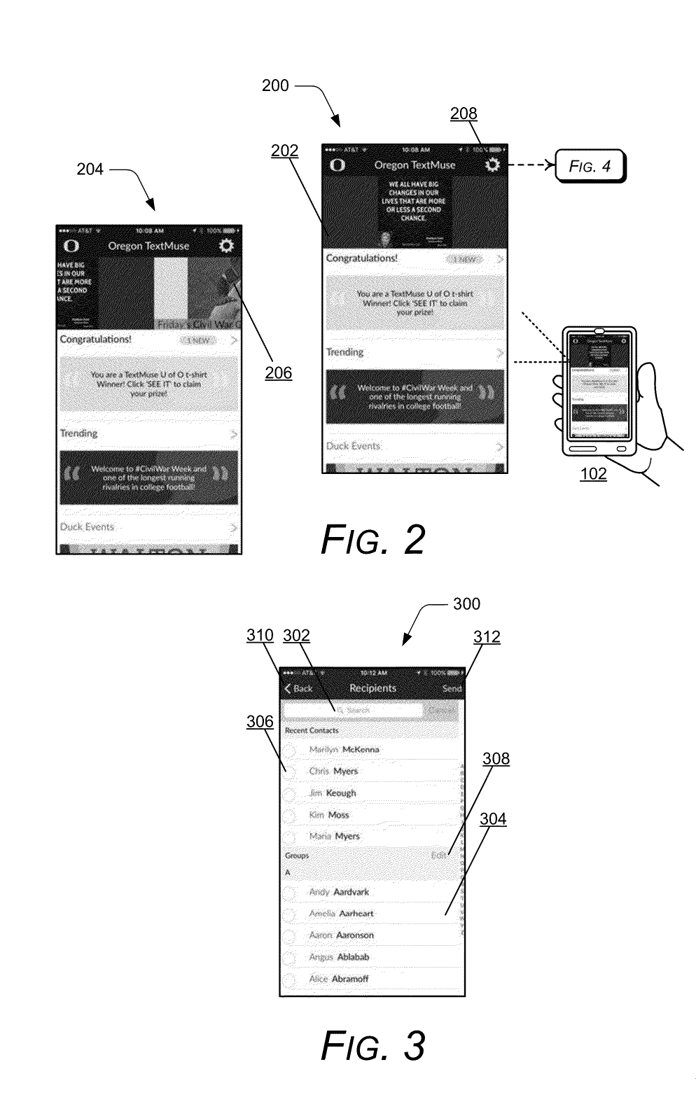

The TextMuse application 130 has various user interfaces 132 that can be displayed on an integrated display device of the mobile device 102 (e.g., on the display device 134 of the mobile phone 104, for example). The user interfaces 132 of the TextMuse application are shown and further described with reference to FIGS. 2-8. The user interfaces 132 of the TextMuse application 130 include user-selectable controls and options that are displayed and provided for user interaction with the TextMuse application and the messaging client 118. For example, the TextMuse application 130 can receive a selection of one or more user contacts 136 that are maintained on the mobile device 102, and receive another selection of preconfigured messaging content 126 (e.g., either maintained at the TextMuse service provider 114 or downloaded to the mobile device 102). The user contacts 136 may be obtained from another application on the mobile device 102 (e.g., from the messaging client application 118), or may be maintained as a list of user contacts that are integrated or associated with the TextMuse application 130. Further, as the user contacts 136 associated with the TextMuse application 130, the list of user contacts may optionally be populated from other device applications, as controlled by the user of the mobile device.

The TextMuse application 130 can then generate a content-ready text message 138 that includes at least the preconfigured messaging content, and the content-ready text message is communicated by the messaging client application 118 from the mobile device 102 to the client device 104 that is associated with the selected user contact. The TextMuse application 130 can initiate the communication of the content-ready text message 138, by the messaging client application 118, to client devices that are associated with the one or more user contacts. The TextMuse application 130 transfers the content-ready text message 138 to the messaging client application 118 that manages communication of the content-ready text message to the client devices.

In implementations, the TextMuse application 130 can be downloaded as an independent application (e.g., from the TextMuse service provider 114 or from any other application store) and interfaces with the native messaging client application 118 on the mobile device. The TextMuse application 130 can be interfaced with the messaging client application 118 via application programming interfaces (APIs) and other mechanisms that are designed to interface device applications with each other and/or with the operating system of the device. The TextMuse application 130 can also be implemented to access the user contacts 136 and other data on the mobile device 102, such as photos, social media feeds, or other data that the application is permissioned to access on the device.

FIG. 2 illustrates an example user interface of the TextMuse application described with reference to FIG. 1. The user interface is a start screen 200 from a which a user can select a category 202 of suggested text messages (also referred to herein as the preconfigured messaging content from which the content-ready text messages are generated). In implementations, a user can select the options by tapping on the touchscreen of the mobile device 102 to transition into the selected category, such as shown at 204 with the slider 206 at the top of the screen.

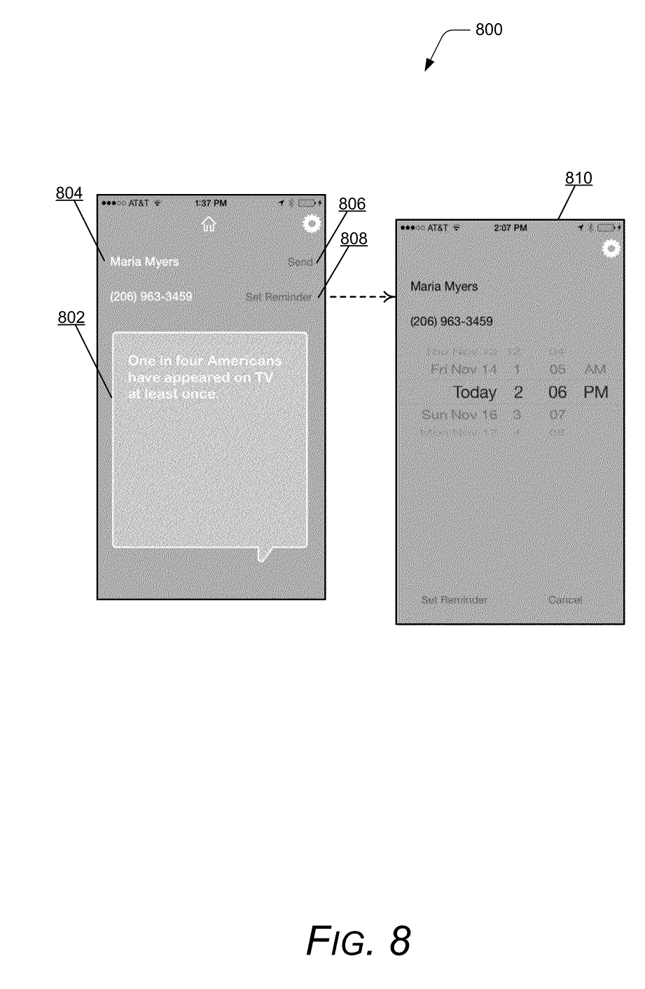

The start screen 200 also includes settings option 208 that a user can select to initiate an options screen (FIG. 4) where the user can configure features of the TextMuse application 130 and change the application settings. The start screen 200 also includes animations of suggested text messages or recipients which are displayed at regular intervals. For example, an animation expands to display a suggested text message that the user can select (e.g., with a touch input on the touchscreen of the device), and the application display will transition directly to the suggested text selection, such as shown in FIG. 6.

FIG. 3 illustrates an example user interface of the TextMuse application described with reference to FIG. 1. The user interface is the contacts screen 300 from which a user can select one or more text recipients of a content-ready text message. A user can search for a contact using the search field 302 by entering a portion of the contact's name, and searched contacts matching the search field information in the search box are listed and updated as new information is provided. Contacts in the contacts list 304 can be selected or added to a group for sending a text message. A user can select an existing contact, group of contacts, or a recent contact by tapping on the name in the contacts list. A user can also add a contact, group of contacts, or a recent contact to a group text message by toggling a contact selector 306, adding them to a list of text recipients. A user can also find contacts by scrolling through the contacts list 304 or by tapping on the letter corresponding to the last name of a contact, which displays the first contact with a first or last name beginning with the selected letter.

A user can create a new group of the selected contacts by initiating the new group option 308, shown in this example as the “edit” feature displayed in the contacts screen 300, and then selecting a name for the created group. The user can select the home button 310 (e.g., shown as a “<Back” button) to return the device display to the start screen 200 (FIG. 2). A user can also initiate sending a text message to the one or more selected recipients by selecting the text send option 312 shown displayed in the top right corner of the contacts screen.

FIG. 4 illustrates an example user interface of the TextMuse application described with reference to FIG. 1. The user interface is the options screen 400 where the user can configure features of the TextMuse application 130 and change the application settings. A user can select which categories 402 of the content-ready text messages are displayed by toggling a category selector 404 that is associated with each category name of the suggested categories. A user can scroll up and down through the category list by swiping across the touchscreen with a gesture input 406 to display the categories 402 and any number of additional categories. Optionally, a user can initiate tracking of recent contacts, listing them in the contacts list as shown and described with reference to FIG. 3, by toggling the associated feature selector 408. The user can also control how many of the recent contacts are listed using the corresponding slider bar 410, increasing or decreasing the number of recent contacts that are listed.

Similarly, a user can track recent notes by toggling the associated feature selector 412, and can control how many of the recent messages are listed using the corresponding slider bar 414, increasing or decreasing the number recent messages that are listed. Similarly, a user can turn scheduled text notifications and reminders on or off by toggling the associated feature selector 416. From the options screen 400, a user can also register their TextMuse application by selecting the “Register” option 418 that is displayed at the bottom of the screen and/or provide feedback by selecting the “Feedback” option 420.

Additionally, from the settings screen 400, the user can initiate to select different versions of the TextMuse application by selecting the “Versions” option 422 that is displayed at the bottom of the screen, which can initiate display of the versions screen 424. The device user can choose content specific to a university or other affiliation from the additional set of content categories by selecting from the “Versions” list of current options. As shown in this example, the user can select the “Main” version, which includes the standard content categories, or from other selections such as “Oregon” for the University of Oregon, which adds new categories to the main screen, like “Events,” “Sports” and other selectable options.

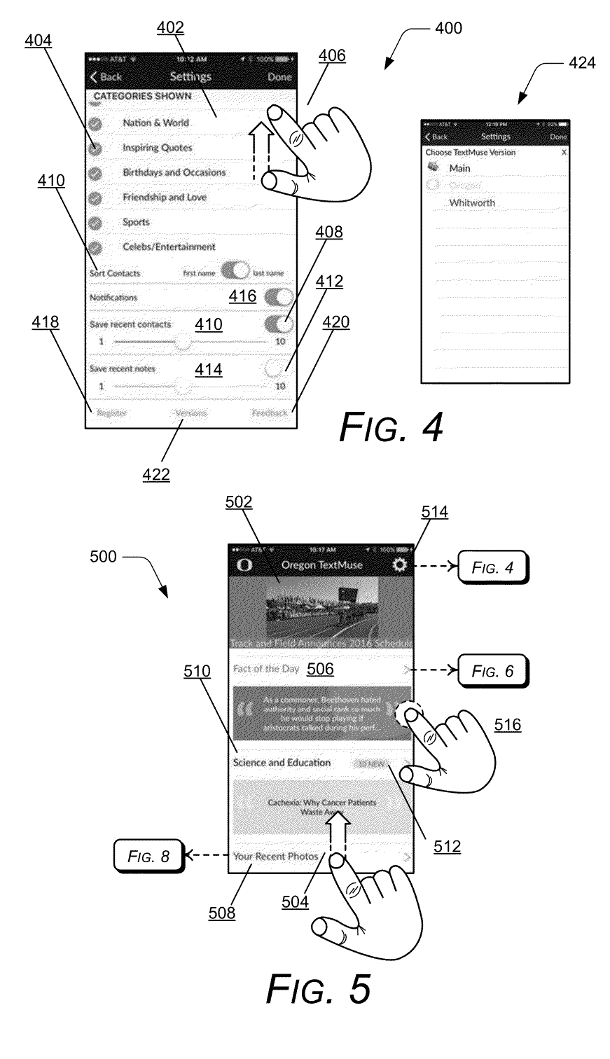

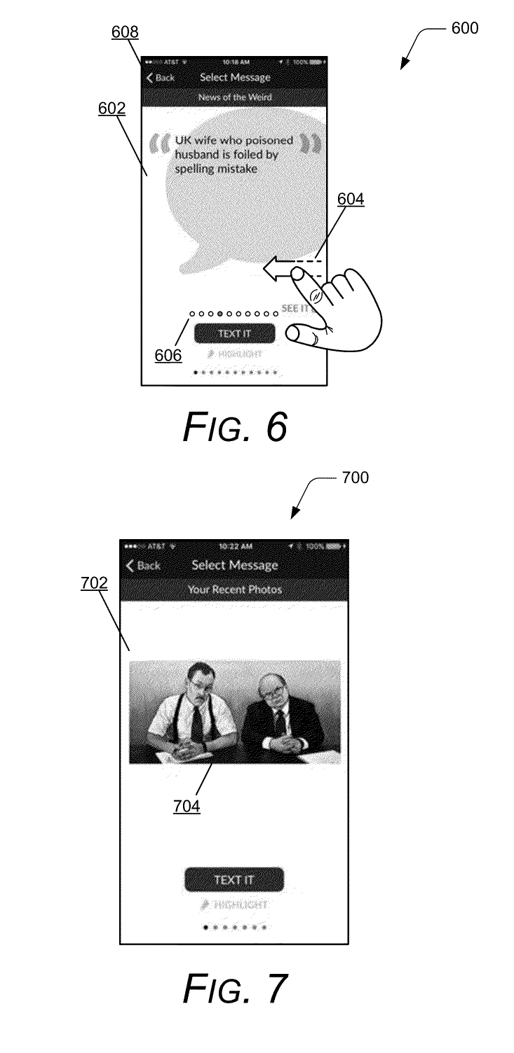

FIG. 5 illustrates an example user interface of the TextMuse application described with reference to FIG. 1. The user interface is a category selection screen 500 from which the user can select a category of suggested text messages (also referred to herein as the preconfigured messaging content from which the content-ready text messages are generated). The category selection screen 500 includes a listing of categories 502 that are displayed as selectable options for user selection, and a user can swipe across the touchscreen with a gesture input 504 to continue the different categories being listed. In implementations, the categories may include any number of categories displayed on any number of screens (e.g., one category selection screen 500 having the listing of categories displayed over any number of scrolled screens). Further, the categories include the available categories, selected categories, version-specific categories, and some required categories, and may be the same as shown in this example, changed regularly by the TextMuse service provider 114, and/or any combination thereof

A user can select a particular category by tapping on the touchscreen of the corresponding category, which then initiates a transition to an associated suggested text screen (FIG. 6). For example, a user selection of the category 506 will transition to the first associated suggested text screen that displays a suggested text message (e.g., the preconfigured messaging content) having content that includes a fact of the day. Similarly, a user selection of the category “Your Recent Photos” 508 will transition to the first associated text screen (FIG. 7) that displays a photo stored on the mobile device 102 (e.g., providing that the TextMuse application has been permissioned to access the device-stored photos). Similarly, a user selection of the category “Science & Education” 510 will transition to the first associated suggested text screen that displays the preconfigured messaging content.

As shown, the category box for “Science & Education” 510 includes a numerical indication 512 of the new suggested text messages (e.g., new to the user of the device) that are available for user selection in that particular category. In implementations, many or all of the other categories can also display a numerical indication of the new suggested text messages that are available for user selection in a given category. As described with reference to the other screens, a user can select a back button or home button to return the device display to the start screen 200 (FIG. 2). Similar to the start screen 200, the category selection screen 500 also includes a settings option 514 that the user can select to initiate the options screen (FIG. 4) where the user can configure features of the TextMuse application 130 and change the application settings.

The category selection screen 500 includes a listing of the categories that are displayed as selectable options for user selection, such as a user touch-selection input 516 to select a category. The category selection input initiates a transition to display an associated suggested text screen. For example, a user selection of the category 506 will transition to the first associated suggested text screen that displays the preconfigured messaging content of the suggested text message having content that correlates to the selected category. A user can also initiate a refresh of any of the screens with swipe, pull-down of the displayed screen.

FIG. 6 illustrates an example user interface of the TextMuse application described with reference to FIG. 1. The user interface is a suggested text screen 600, which in this example, is a suggested text screen that displays the preconfigured messaging content of a suggested text message 602 having content that includes a message when a user selects the category “News of the Weird” on the category selection screen 500 (FIG. 5). In implementations, a suggested text message (e.g., preconfigured messaging content) can include several elements, such as text, hyperlinks, photos, images, video previews, and/or any other type of text message content. A user can navigate through the several suggested text messages that are associated with a particular category by swiping right or left on the touchscreen of the device with a gesture input 604 to transition to the previous or next suggested text message. The number of available text messages are indicated by a graphic 606, which in this example, are circular indications that each represent one of the suggested text messages associated with the particular category, and the current suggested text message is highlighted to indicate the currently displayed text message for the user. The user can return to the category selection screen 500 by tapping the “back” button 608 of the suggested text message 602.

FIG. 7 illustrates an example user interface of the TextMuse application described with reference to FIG. 1. The user interface is a suggested text screen 700, which in this example, displays a suggested text message 702 that includes a photo 704 when a user selects the category “Your Recent Photos” 508 on the category selection screen 500 (FIG. 5). The suggested text screen 700 includes a recent photo that is maintained on the mobile device 102, and generally, the suggested text screen includes the options and features described with reference to the suggested text screen shown in FIG. 6.

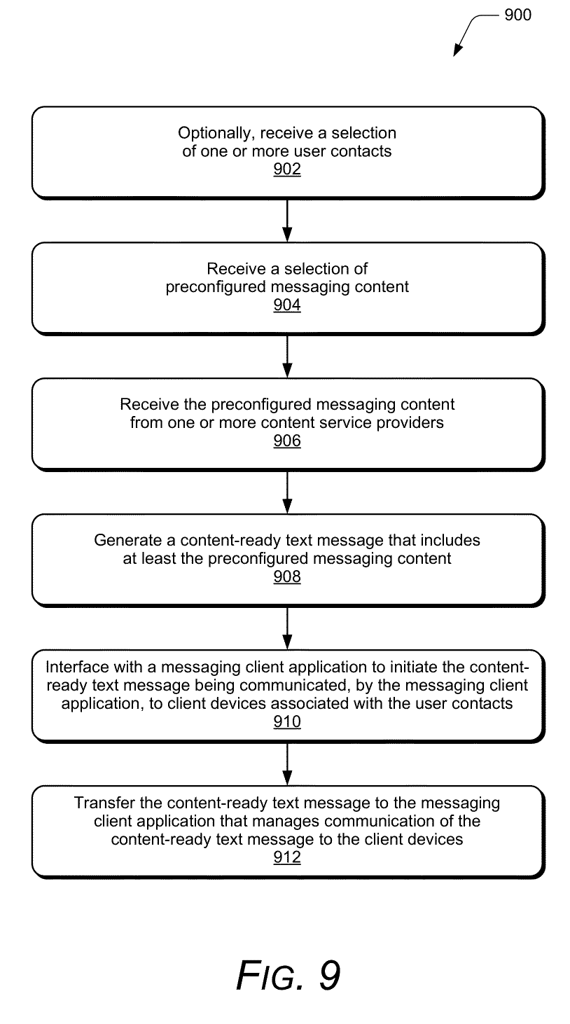

FIG. 8 illustrates an example user interface of the TextMuse application described with reference to FIG. 1. The user interface is a preview screen 800 that is displayed before a text message is sent, and from which a user can select to send a suggested text message 802 that has been chosen to send to a recipient. After selecting a suggested text message 802, the display transitions to the preview screen 800 if a contact 804 has already been selected from the contacts screen 300 (FIG. 3). A user can preview the text message and then initiate sending it to the SMS or MMS messaging client application 118 of the mobile device 102 by selecting the “Send” option 806 on the preview screen.

A user can also edit the suggested text message 802 by tapping on the touchscreen to select the text message box displayed on the preview screen. Alternatively, if a contact has not been selected before the suggested text message, then the display can transition to the contacts screen 300 (FIG. 3) from which a user can select the one or more text recipients. The user can also set a reminder to send the selected text message at a particular day and time by selecting the “Set Reminder” option 808, which transitions to a reminder screen 810. The user can then set the day and/or time for the TextMuse application 130 to automatically initiate sending the selected text message to the selected one or more recipients.

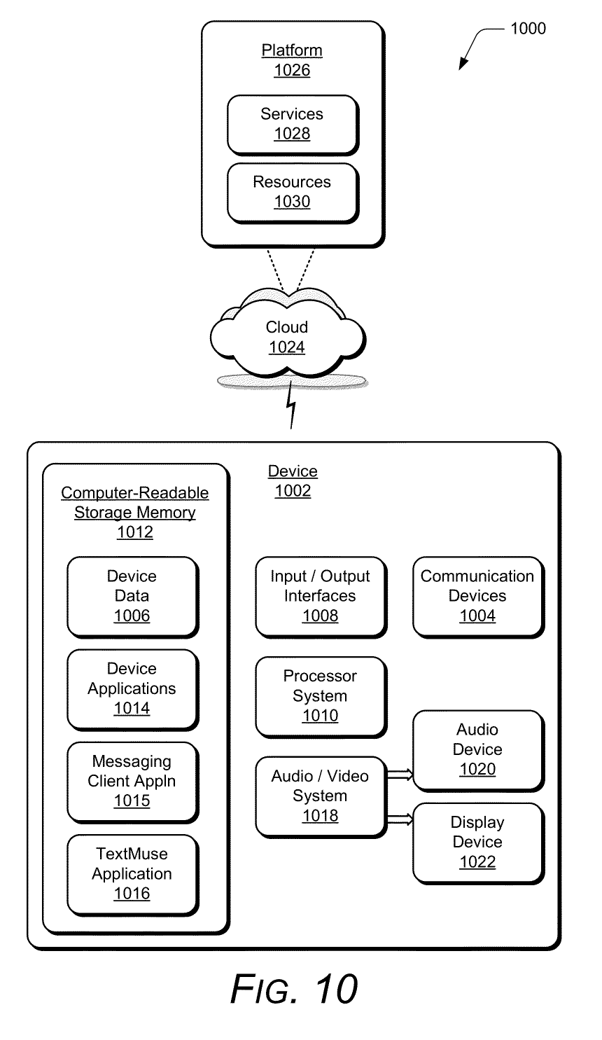

Example method 900 is described with reference to FIG. 9 in accordance with one or more embodiments of TextMuse message generator. Generally, any of the components, modules, methods, and operations described herein can be implemented using software, firmware, hardware (e.g., fixed logic circuitry), manual processing, or any combination thereof Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 9 illustrates example method(s) 900 of TextMuse message generator, and is generally described with reference to the TextMuse application that is implemented by the mobile device as shown in the example system of FIG. 1. The order in which the method is described is not intended to be construed as a limitation, and any number or combination of the method operations can be combined in any order to implement a method, or an alternate method.

At 902, a selection of one or more user contacts is received, or optionally, the user may skip this step. For example, the TextMuse application 130 that is implemented by the mobile device 102 receives a selection of one or more user contacts 136 that are maintained on the mobile device 102. Alternatively, the user can select contacts as recipients of the content-ready text message after the TextMuse application 130 transfers the content-ready text message to the messaging client application 118.

At 904, an additional selection of preconfigured messaging content is received and, at 906, the preconfigured messaging content is received from a content service provider. For example, the TextMuse application 130 that is implemented by the mobile device 102 receives a selection of the preconfigured messaging content 126 (e.g., either maintained at the TextMuse service provider 114 or downloaded to the mobile device 102), and the preconfigured messaging content 126 is received from the TextMuse service provider 114.

At 908, a content-ready text message is generated that includes at least the preconfigured messaging content. For example, the TextMuse application 130 that is implemented by the mobile device 102 generates the content-ready text message 138 that includes at least the preconfigured messaging content 126 (e.g., as selected at 904). The TextMuse application 130 generates the content-ready text message 138 as an application independent from the messaging client application 118, and can independently generate the content-ready text message 138 to include the selected preconfigured messaging content 126 and the selected user contacts 136.

At 910, a messaging client application is interfaced to initiate the content-ready text message being communicated, by the messaging client application, to client devices that are associated with the one or more user contacts. For example, the TextMuse application 130 interfaces with the messaging client application 118 to initiate the content-ready text message 138 being communicated, by the messaging client application, to client devices 104 that are associated with the selected user contacts 136. In implementations, the TextMuse application 130 is designed to interface with multiple, different messaging client applications to initiate communication of content-ready text messages via the multiple, different messaging client applications.

At 912, the content-ready text message is transferred to the messaging client application that manages communication of the content-ready text message to the client devices. For example, the TextMuse application 130 transfers the content-ready text message 138 to the messaging client application 118 that manages communication of the content-ready text message to the client devices. The messaging client application 118 can be implemented for Short Message Service (SMS) texting, and the TextMuse application 130 hands-off the content-ready text message 138 for communication as a SMS text. Alternatively, the messaging client application 118 can be implemented for Multimedia Messaging Service (MMS) texting, and the TextMuse application 130 hands-off the content-ready text message 138 for communication as a MMS text.

FIG. 10 illustrates an example system 1000 that includes an example device 1002, which can implement embodiments of a TextMuse message generator. The example device 1002 can be implemented as any of the computing devices and/or services (e.g., server devices) described with reference to the previous FIGS. 1-9, such as any type of computing device, client device, mobile phone, tablet device, communication, entertainment, gaming, media playback, and/or other type of device. For example, the mobile device 102, the client device 104, and the TextMuse service provider 114 shown in FIG. 1 may be implemented as the example device 1002.

The device 1002 includes communication devices 1004 that enable wired and/or wireless communication of device data 1006, such as text messages, preconfigured messaging content, and content-ready text messages from one computing device to another. The device data can include any type of text, audio, video, and/or image data, such as text messages that are provided by the TextMuse application executing on the device. The communication devices 1004 can also include transceivers for cellular phone communication and/or for network data communication.

The device 1002 also includes input/output (I/O) interfaces 1008, such as data network interfaces that provide connection and/or communication links between the device, data networks, and other devices. The I/O interfaces can be used to couple the device to any type of components, peripherals, and/or accessory devices, such as a digital camera device that may be integrated with device 1002. The I/O interfaces also include data input ports via which any type of data, media content, and/or inputs can be received, such as user inputs to the device, as well as any type of audio, video, and/or image data received from any content and/or data source.

The device 1002 includes a processing system 1010 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 1002 may further include any type of a system bus or other data and command transfer system that couples the various components within the device. A system bus can include any one or combination of different bus structures and architectures, as well as control and data lines.

The device 1002 also includes computer-readable storage memory 1012, such as data storage devices that can be accessed by a computing device, and that provide persistent storage of data and executable instructions (e.g., software applications, modules, programs, functions, and the like). Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 1012 provides storage of the device data 1006 and various device applications 1014, such as an operating system that is maintained as a software application with the computer-readable storage memory and executed by the processing system 1010. In this example, the device applications include a messaging client application 1015, and also include a TextMuse application 1016 that implements embodiments of a TextMuse message generator, such as when the example device 1002 is implemented as the mobile device 102 shown in FIG. 1. An example of the TextMuse application 1016 includes the TextMuse application 130 that is implemented by the mobile device 102, as described with reference to FIGS. 1-9.

The device 1002 also includes an audio and/or video system 1018 that generates audio data for an audio device 1020 and/or generates display data for a display device 1022. The audio device and/or the display device include any devices that process, display, and/or otherwise render audio, video, display, and/or image data, such as the image content of a digital photo. In implementations, the audio device and/or the display device are integrated components of the example device 1002. Alternatively, the audio device and/or the display device are external, peripheral components to the example device. In embodiments, at least part of the techniques described for TextMuse message generator may be implemented in a distributed system, such as over a “cloud” 1024 in a platform 1026. The cloud 1024 includes and/or is representative of the platform 1026 for services 1028 and/or resources 1030. For example, the services 1028 may include the content providers 116 and the TextMuse service provider 114, and the resources 1030 may include the preconfigured messaging content 126 as described with reference to FIGS. 1-10.

The platform 1026 abstracts underlying functionality of hardware, such as server devices (e.g., included in the services 1028) and/or software resources (e.g., included as the resources 1030), and connects the example device 1002 with other devices, servers, etc. The resources 1030 may also include applications and/or data that can be utilized while computer processing is executed on servers that are remote from the example device 1002. Additionally, the services 1028 and/or the resources 1030 may facilitate subscriber network services, such as over the Internet, a cellular network, or Wi-Fi network. The platform 1026 may also serve to abstract and scale resources to service a demand for the resources 1030 that are implemented via the platform, such as in an interconnected device embodiment with functionality distributed throughout the system 1000. For example, the functionality may be implemented in part at the example device 1002 as well as via the platform 1026 that abstracts the functionality of the cloud 1024.

Although embodiments of TextMuse message generator have been described in language specific to features and/or methods, the appended claims are not necessarily limited to the specific features or methods described. Rather, the specific features and methods are disclosed as example implementations of the TextMuse message generator, and other equivalent features and methods are intended to be within the scope of the appended claims. Further, various different embodiments are described and it is to be appreciated that each described embodiment can be implemented independently or in connection with one or more other described embodiments.

1. A computing device, comprising:
memory configured to maintain user contacts;
a processor system configured to execute software instructions as a TextMuse application that interfaces with a messaging client application executing on the computing device, the TextMuse application implemented to:
receive an additional selection of preconfigured messaging content;
generate a content-ready text message that includes at least the preconfigured messaging content; and
initiate communication of the content-ready text message, by the messaging client application, to client devices that are associated with one or more user contacts.

2. The computing device as recited in claim 1, wherein the TextMuse application is implemented to receive the preconfigured messaging content from one or more content service providers, the preconfigured messaging content available for selection to include in the content-ready text message.

3. The computing device as recited in claim 1, wherein the TextMuse application is implemented to transfer the content-ready text message to the messaging client application that manages communication of the content-ready text message to the client devices.

4. The computing device as recited in claim 1, wherein the TextMuse application is configured to interface with multiple, different messaging client applications.

5. The computing device as recited in claim 1, wherein the TextMuse application is independent from the messaging client application, and independently generates the content-ready text message to include the preconfigured messaging content.

6. The computing device as recited in claim 1, wherein the messaging client application implements Short Message Service (SMS) texting; and
the TextMuse application is implemented to hand-off the content-ready text message for communication as a SMS text.

7. The computing device as recited in claim 1, wherein the messaging client application implements Multimedia Messaging Service (MMS) texting; and
the TextMuse application is implemented to hand-off the content-ready text message for communication as a MMS text.

8. A method, comprising:
receiving a selection of preconfigured messaging content;
generating a content-ready text message that includes at least the preconfigured messaging content; and
interfacing with a messaging client application to initiate the content-ready text message being communicated, by the messaging client application, to client devices that are associated with one or more user contacts.

9. The method as recited in claim 8, further comprising:
receiving the preconfigured messaging content from one or more content service providers, the preconfigured messaging content available for selection to include in the content-ready text message.

10. The method as recited in claim 8, further comprising:
transferring the content-ready text message to the messaging client application that manages communication of the content-ready text message to the client devices.

11. The method as recited in claim 8, further comprising:
interfacing with multiple, different messaging client applications to initiate communication of content-ready text messages via the multiple, different messaging client applications.

12. The method as recited in claim 8, wherein a TextMuse application said generates the content-ready text message, the TextMuse application being independent from the messaging client application, and independently generating the content-ready text message to include the preconfigured messaging content.

13. The method as recited in claim 8, wherein the messaging client application implements Short Message Service (SMS) texting; and
the method further comprising handing-off the content-ready text message for communication as a SMS text.

14. The method as recited in claim 8, wherein the messaging client application implements Multimedia Messaging Service (MMS) texting; and
the method further comprising handing-off the content-ready text message for communication as a MMS text.

15. A computer-readable storage memory device comprising a TextMuse application stored as software instructions that are executable and, responsive to execution of the instructions by a computing device, the computing device performs operations comprising to:
receive a selection of a user contact;
receive an additional selection of preconfigured messaging content;
generate a content-ready text message that includes at least the preconfigured messaging content; and
interface with a messaging client application executing on the computing device to initiate the content-ready text message being communicated to a client device that is associated with the user contact.

16. The computer-readable storage memory device as recited in claim 15, wherein the computing device performs the operations of the TextMuse application further comprising to receive the preconfigured messaging content from one or more content service providers, the preconfigured messaging content available for selection to include in the content-ready text message.

17. The computer-readable storage memory device as recited in claim 15, wherein the computing device performs the operations of the TextMuse application further comprising to transfer the content-ready text message to the messaging client application that manages communication of the content-ready text message to the client device.

18. The computer-readable storage memory device as recited in claim 15, wherein the computing device performs the operations of the TextMuse application further comprising to interface with multiple, different messaging client applications to initiate communication of content-ready text messages via the multiple, different messaging client applications.

19. The computer-readable storage memory device as recited in claim 15, wherein the TextMuse application is independent from the messaging client application, and the computing device performs the operations of the TextMuse application further comprising to independently generate the content-ready text message to include the preconfigured messaging content and the one or more user contacts.

20. The computer-readable storage memory device as recited in claim 15, wherein:
the messaging client application implements one of Short Message Service (SMS) texting or Multimedia Messaging Service (MMS) texting; and
the computing device performs the operations of the TextMuse application further comprising to hand-off the content-ready text message for communication as one of a SMS text or a MMS text.
